(19) United States
(12) Patent Application Publication
(10) Pub. No.: US 2010/0260394 A1
(43) Pub. Date: Oct. 14, 2010

(54) IMAGE ANALYSIS OF BRAIN IMAGE DATA

(75) Inventors: Kirsten Meetz, Hamburg (DE); Thomas Buelow, Grosshansdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,933

(22) PCT Filed: Dec. 5, 2008
(86) PCT No.: PCT/IB2008/055119

§ 371 Date: Jun. 9, 2010

(30) Foreign Application Priority Data
Dec. 14, 2007 (EP) 07123196.3

(51) Int. Cl. G06T 7/00; G06K 9/56

(52) U.S. Cl. 382/128; 382/195

(57) ABSTRACT

The present invention relates to analysis of image data, e.g. brain image data, where regions of interest are identified in patient specific image data based on non-image data. The brain image data is analyzed by correlating non-image data (20) in the form of data indicative of a neurological deficit and an object model (21) to identify one or more regions of interest (22) in the brain model, mapping the brain model to patient specific brain image data to obtain target image data (24), and identifying the one or more regions of interest in the target image data.

### FIELD OF THE INVENTION

The present invention relates to a system of analyzing image data, and in particular to a system for identifying regions of interest in patient specific image data based on non-image data.

### BACKGROUND OF THE INVENTION

In image analysis of suspected malignant tissue it may be difficult to distinguish accurately between many diseases that can produce a similar or even identical effect in the image data. Likewise it may be difficult to identify areas which have undergone only subtle changes. As an example, it may be difficult, especially for the inexperienced practitioner, to detect an early stage hemorrhagic stroke in brain images. The brain is a very sensitive organ regarding the loss of neurons and recovering from damage. In connection with brain lesions it is therefore crucial to detect and diagnose any lesions as early as possible, and ideally even before any anatomical changes occur. Therefore, the early detection and differential diagnosis of a brain lesion can typically not be based on image data alone. Clinical and neurological findings have to be added to arrive at a diagnosis. This makes the diagnostic procedure a multi-disciplinary task that has to be performed under an enormous time-pressure, combining the expertise of a neurologist and a well-trained radiologist. However, in clinical practice such a setting can not be guaranteed.

In U.S. Pat. No. 5,463,548 it is proposed to use computer-aided differential diagnosis based on inputted clinical parameters and radiographic information in connection with image analysis. The solution is based on neural networks and directed to applications with respect to interstitial lung diseases and mammographic information analyses.

The inventors of the present invention have appreciated that an improved way of image analysis of brain image data is of benefit, and have consequently devised the present invention.

### SUMMARY OF THE INVENTION

The invention preferably seeks to mitigate, alleviate or eliminate one or more of the above mentioned disadvantages singly or in any combination. It may be seen as an object of the present invention to provide a system that solves the above mentioned problems, or other problems, of the prior art. In particular, it may be seen as an object of the present invention to provide means which facilitate improved analysis of image data such as brain image data, for example. This object and several other objects are achieved in a first aspect of the invention by providing an image analysis system comprising:

an input unit for receiving data indicative of a deficit and for receiving image data describing at least part of an object;

a storage unit for storing an object model, where each voxel or group of voxels is associated with one or more labels, the one or more labels comprising an anatomical label and a deficit label; and

a correlating unit for correlating the data indicative of the deficit and the object model to identify one or more regions of interest in the object model;

a mapping unit for mapping the object model to the image data to obtain target image data;

an identifying unit for identifying the one or more regions of interest in the target image data.

Non-image clinical data in the form of clinical and/or functional data indicative of a deficit are used to identify one or more regions of interest in an object model. The object model is subsequently mapped to the image data, enabling identifying the target image data on the basis of the labels associated with voxels or groups of voxels. That allows identifying one or more regions of interest in the image data. Such regions of interest may be suspected to be responsible for the observed neurological deficit. The data indicative of the deficit may be received via user interactions or via interfacing to a clinical information system.

In general it may be difficult to detect and interpret subtle changes in image data, and it is an advantage of the present invention that from a combination of the non-image-based clinical or functional findings and the image-based information, the medical practitioner is directed to the relevant area of the image data to assist the medical practitioner in making the diagnosis. In general a region of interest is the region under investigation or examination.

In an advantageous embodiment, the identified one or more regions of interest in the target image data are visualized. In general, despite of the availability of detailed 3D images of the object it is still challenging for the medical practitioner to efficiently extract information from the data. By identifying the one or more regions of interest in the target image data the visualization process is rendered efficient for the medical practitioner.

In advantageous embodiments, an image analysis system is used for analyzing brain image data. The object is a brain and the deficit is a neurological deficit. This is a very useful application of the image analysis system of the invention.

In an advantageous embodiment, image-based computations are automatically performed on at least the part of the image data pertaining to the one or more regions of interest. Computations only in relevant areas of the image data may thus be ensured.

In advantageous embodiments, a number of labels may be assigned to the voxels or group of voxels of the object, e.g. the brain model, thereby providing a more comprehensive information tool to the medical practitioner. In an embodiment, the one or more labels further comprise a functional label, and/or a label indicative of the probability of a structural defect such as a lesion.

In an advantageous embodiment, the system may further comprise or be connected to a decision support system. A decision support system may advise the medical practitioner, based on existing knowledge, as well as provide a prediction of the course of the disease, thereby reducing the time delay involved in obtaining a diagnosis as well as increasing the certainty of a given diagnosis. The decision support system may also advise the user or the system on any parameters to be used in the visualization of image processing of the region of interest.

In accordance with a second aspect of the invention, there is provided a method of analyzing image data describing at least part of an object, comprising:

receiving data indicative of a deficit;

receiving the image data describing the at least part of the object;

accessing an object model where each voxel or group of voxels is associated with one or more labels, the one or more labels comprising an anatomical label and a deficit label;

correlating the data indicative of the deficit and the object model to identify one or more regions of interest in the object model;

mapping the object model to the image data to obtain target image data; and

identifying the one or more regions of interest in the target image data.

In accordance with a third aspect of the invention, there is provided a medical acquisition apparatus further comprising an acquisition unit for acquiring image data in the form of one or more sets of voxel data. The acquisition unit may be a medical scanner.

In accordance with a fourth aspect of the invention, there is provided a computer program product having a set of instructions for use on a computer, the instructions being arranged to cause the computer to perform the functionality of any of the aspects of the invention. The computer may be a computer system, such as a specially programmed general-purpose computer, in the form of either a stand-alone computer system or a distributed computer system.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows a flow diagram in accordance with an exemplary embodiment of the present invention;

FIG. 2 provides a schematic illustration of an exemplary embodiment of the invention;

FIG. 3 illustrates a flow diagram of various exemplary uses of the target image data;

FIG. 4 schematically illustrates components of a visualization system in accordance with the present invention;

### DESCRIPTION OF EMBODIMENTS

Embodiments of the invention will be illustrated with references to exemplary brain image data. The image analysis system in these embodiments is adapted to perform the brain image data analysis based on a neurological deficit resulting from a brain defect such as a lesion. Those skilled in the art will understand, however, that the invention may be applied to analyzing image data describing other regions of the human or animal anatomy, e.g. the heart, liver, lungs, femur or cardiac arteries. The brain example should not be construed as limiting the scope of the invention.

The diagnostics of lesions of the brain is a multi-disciplinary task where information from different sources is gathered and combined. For example, information from clinical investigations, neurological tests, imaging and laboratory tests is combined and evaluated by the medical practitioner to arrive at a diagnosis. An important tool in arriving at the diagnosis is the use of image data. However, it may be difficult for the practitioner to locate the region of interest based on the image data alone. Especially in the situation where the lesions only show very subtle changes in the image data.

In neurology there is a well-defined correlation between neurological deficits and different parts of the brain. In the present invention, this correlation is used to identify one or more regions of interest in brain image data, such as the location of a suspected brain lesion.

Examples of correlations between a neurological deficit and brain anatomy include, but are not limited to, the following list (TABLE 1):

| Name | Neurological deficit | Anatomic label |
|---|---|---|
| Paralysis | loss of simple movement of | frontal lobe |
| | various body parts | |
| Alexia | problems with reading | parietal lobe |
| Color Agnosia | difficulty with identifying | occipital lobe |
| | colors | |

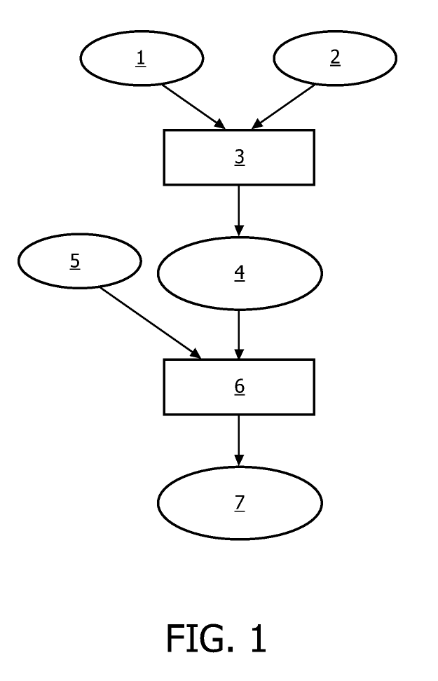

A flow diagram in accordance with an exemplary embodiment of the present invention is illustrated in FIG. 1.

Neurological data in terms of data indicative of a neurological deficit are received 1, for example by inputting it into a computer system. Moreover, a brain model is received or accessed 2. The brain model may be a 3D model where each voxel or group of voxels is associated with one or more labels. Alternatively, the brain model may be a 2D model of a section of the brain, where each pixel or group of pixels is associated with one or more labels. A 3D brain model may comprise a stack of slices, each slice defining a 2D model. Hereinafter, both voxels and pixels are referred to as voxels. The brain model is a virtual model of the brain. A brain model is also referred to in the art as a brain atlas.

The one or more labels comprise an anatomical label and a neurological deficit label. That is, each voxel or group of voxels is associated with one or more neurological deficits and the anatomy occupied by the voxel or group of voxels. The association may be defined in the brain model. In addition to anatomical labels and neurological deficit labels, other labels may be assigned to each voxel or group of voxels. In particular a functional label may be assigned. A functional label may indicate a function of a specific anatomical area, such as the relevant anatomical areas for breathing or heart rate are assigned to the relevant voxels.

The data indicative of a neurological deficit and the brain model are correlated 3 to identify one or more regions of interest (ROI) in the brain model, thereby identifying one or more regions which are suspected to induce the observed neurological deficit. An individual patient specific brain model 4 is thereby obtained.

Brain image data of at least part of a brain is received or accessed 5, and the brain model is mapped 6 to the brain image data to obtain target image data. The one or more regions of interest in the target image data are identified 7 in order to obtain patient specific image data. In an embodiment, the mapping of the brain model onto the brain image data is based on an implementation of an elastic registration of a brain template. Alternatively or additionally, the brain model may comprise a voxel classifier, and the analysis of the brain may comprise classifying voxels of the brain image data. A person skilled in the art will understand that other brain models may be employed to obtain the target image data.

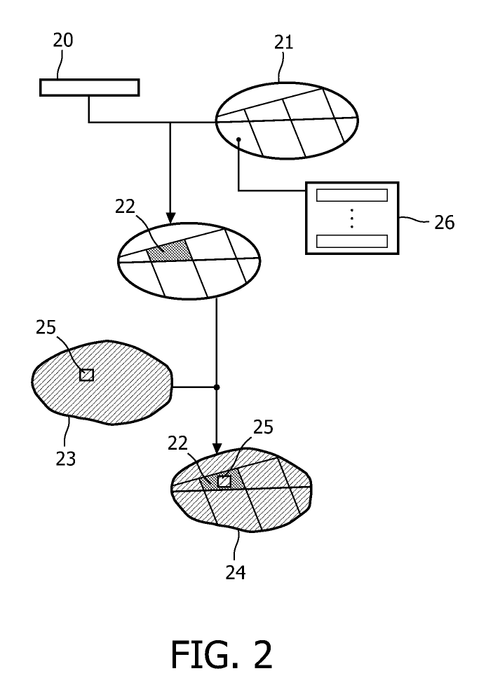

FIG. 2 provides a schematic illustration of an exemplary embodiment of the invention.

Data 20 indicative of a neurological deficit is provided. The data may be provided via user interactions, e.g. via selecting the relevant item from a list, via interfacing to a clinical information system, such as an electronic patient record, a radiological information system, a hospital information system, etc.

A brain model 21 (here schematically illustrated) is accessed. The brain model may be stored at a local computer system or at a computer system that may be accessed through a network, such as the Internet, an Intranet or any other type of network. In the schematically illustrated model nine groups of voxels are identified. Each group of voxels may be associated with one or more labels 26. In general any brain model within the scope of the invention may be used.

The data 20 indicative of a neurological deficit and the brain model 21 are correlated to identify one or more regions of interest 22 in the brain model. The correlation may be performed by any suitable method. For example, having identified the neurological deficit, the one or more anatomical regions correlated with this neurological deficit are selected in the brain model. For example, all voxels which carry the relevant “neurological deficit or anatomical” label are selected e.g. by using a table such as TABLE 1. For more complex diagnostic tasks, methods may be used that incorporate a function which defines the correlation between one or more neurological symptoms and one or more labels. Such correlation functions may be based on heuristics, rules or other means.

Brain image data 23 (here schematically illustrated) of at least part of a brain is received. In the brain image data, a brain lesion 25 is schematically illustrated.

The brain model 22 is mapped to the brain image data 23 to obtain target image data 24. From the mapping, the one or more regions of interest are transferred to the patient specific brain image data 23, thereby identifying the ROI (or ROIs) 22 covered by the lesion 25 in the image data of the patient.

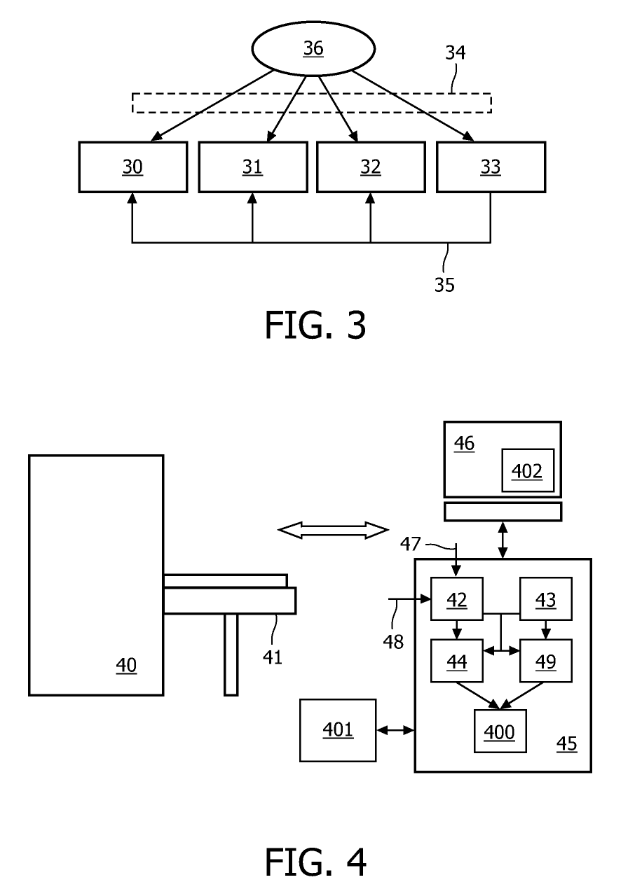

FIG. 3 illustrates a flow diagram of various exemplary further uses of the target image data 7, 36.

In an exemplary embodiment, the identified region or regions of interest in the target image data 36 are visualized 30. The visualization may be done in order to assist the reading or analysis of the image data. As an example, all of the target image data may be visualized using a medical visualization, such as 3D visualization. Alternatively, only the identified one or more regions of interest may be visualized.

The visualization may be a highlighting of the ROI to guide the practitioner towards the relevant region or regions, for example in connection with further analysis of the image data. The highlighting may be done by any suitable highlighting means.

In an exemplary embodiment, image analysis in terms of image-based computations is automatically performed 31 on at least the part of the image data pertaining to the one or more regions of interest. The image data may be selected by the user or may automatically be selected in accordance with settings of the executing computer program. Additionally, parameters used in connection with the image-based computations may be selected by the user or automatically selected in accordance with settings of the executing computer program. For example, the size of a brain region affected by the stroke may be computed.

The automatic image-based computation may in a further embodiment be customized 32 to the image modality and/or acquisition protocol used to obtain the image data. Alternatively or additionally, the automatic image-based computation may even be customized to the identified one or more regions of interest. For example, the computation based on CT image data may be arranged to use Hounsfield units for image intensities and may further relay on voxel value, i.e. intensity, ranges typical of specific tissues and pathologies such as lesions.

The visualization of the target image data may be performed in order to validate 33 the image processing. The validation 33 may be performed in order to inspect intermediate results of an otherwise automatic process, to decide on a final result, to choose a specific image processing algorithm, etc. A validation step 35 may also be incorporated as a part of the embodiments 30-32.

The brain model may further comprise a label indicative of the probability of a given lesion. In an embodiment, such probabilities are part of the brain model from the onset. Alternatively, the brain model based on the result of the image-based computations may be updated or enriched with such probability value.

An extension layer 34 may be provided for providing information, parameters, rules, etc. representing knowledge relevant to the image analysis. For example, the extension layer may represent knowledge pertaining to the image acquisition (modality and acquisition protocols) that influences the image-based computations. The extension layer may comprise schemes defining how to combine knowledge originating from different sources. By using an extension layer 34, the image processing may be improved, since the relevant parameters, algorithms etc. may be selected.

Data indicative of a neurological deficit, brain image data, and any identified region of interest, may also be provided into a decision support system for assisting the practitioner in various tasks, e.g. the diagnosis, treatment planning or analysis of the image data.

FIG. 4 schematically illustrates components of a visualization system in accordance with the present invention. The system may be a stand-alone system or may incorporate, or be incorporated in, a medical acquisition apparatus. As indicated schematically in FIG. 4, the medical acquisition apparatus typically includes a bed 41 on which the patient lies or another element for localizing the patient relative to the acquisition unit 40. The acquisition unit may be a medical imaging apparatus. The acquisition unit acquires brain image data in the form of one or more sets of voxel data. The image data is fed into a computer system implementing an image analysis system in accordance with embodiments of the present invention.

In embodiments, the image data may be provided using a technique selected from: magnetic resonance imaging (MRI), computed tomography (CT), positron electron tomography (PET), single photon emission computed tomography (SPECT), ultrasound scanning, temporal X-ray imaging, and rotational angiography.

Data indicative of a neurological deficit is inputted 47 into an input unit 42. As mentioned above, the input may be received via user interactions or via interfacing with a clinical information system. The image data is also received 48 in an input unit 42. In embodiments, the input unit 42 may be implemented as separate units for neurological deficit data and image data. A storage unit 43 stores a brain model, wherein each voxel or group of voxels is associated with one or more labels, the one or more labels comprising an anatomical label and a neurological deficit label. The storage unit 43 may be an external storage unit or may be distributed. A correlating unit 44 correlates the data indicative of a neurological deficit and the brain model to identify one or more regions of interest in the brain model. A mapping unit 49 maps the brain model to the brain image data to obtain target image data; and an identifying unit 400 identifies the one or more regions of interest in the target image data. Any user interactions in connection with the image analysis are typically provided through an interface of a computer system 46. The elements of the visualization system may be implemented by one or more data processors and storage units 45 of a general-purpose or dedicated computer system 45, 46.

The visualization system may further comprise a decision support system, e.g. a decision support system 401 may be implemented in the visualization system, or communicatively connected to the visualization system.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An image analysis system comprising:
an input unit (42) for receiving data (20) indicative of a deficit and for receiving image data (23) describing at least part of an object;
a storage unit (43) for storing an object model (21), where each voxel or group of voxels is associated with one or more labels (26), the one or more labels comprising an anatomical label and a deficit label;
a correlating unit (44) for correlating the data indicative of the deficit and the object model to identify one or more regions of interest (22) in the object model;
a mapping unit (49) for mapping the object model to the image data to obtain target image data (24); and
an identifying unit (400) for identifying one or more regions of interest (22) in the target image data (24).

2. The image analysis system according to claim 1, wherein the image data is brain image data, the deficit is a neurological deficit and the object is a brain.

3. The image analysis system according to claim 1, further comprising a visualization unit (402) to visualize the identified one or more regions of interest in the target image data.

4. The image analysis system according to claim 1, further being arranged for automatically performing image-based computations on at least the part of the image data pertaining to the one or more regions of interest.

5. The image analysis system according to claim 4, wherein the automatic image-based computation is customized to the image modality and/or acquisition protocol used to obtain the image data.

6. The image analysis system according to claim 4, wherein the automatic image-based computation is customized to the identified one or more regions of interest.

7. The image analysis system according to claim 1, wherein the one or more labels further comprise a functional label.

8. The image analysis system according to claim 1, further comprising a decision support system (401), wherein the decision support system receives the data indicative of the deficit, the image data, and any identified region of interest.

9. A method of analyzing image data, comprising:
receiving (1) data indicative of a deficit;
receiving (5) image data describing at least part of an object;
accessing (2) an object model where each voxel or group of voxels is associated with one or more labels, the one or more labels comprising an anatomical label and a deficit label; and
correlating (3) the data indicative of the deficit and the object model to identify one or more regions of interest in the object model;
mapping (6) the object model to the image data to obtain target image data;
identifying (7) the one or more regions of interest in the target image data.

10. A medical image acquisition apparatus according to claim 1, further comprising an acquisition unit for acquiring image data in the form of one or more data sets.

11. A computer program product having a set of instructions for use on a computer, the instructions being arranged to cause the computer to perform the steps of claim 1.
